(19) United States
(12) Patent Application Publication
(10) Pub. No.: US 2011/0140996 A1
(43) Pub. Date: Jun. 16, 2011

(54) SWITCHABLE TRANSMISSIVE/REFLECTIVE ELECTROWETTING DISPLAY

(76) Inventor: Lesley Anne PARRY-JONES, Oxford (GB)

(21) Appl. No.: 12/637,846

(22) Filed: Dec. 15, 2009

(51) Int. Cl. G09G 3/28

(52) U.S. Cl. 345/60

(57) ABSTRACT

A double layer electrowetting display is provided that includes a first electrowetting layer switchable between a reflective mode and a non-reflective mode; and a second electrowetting layer, adjacent the first electrowetting layer, including a plurality of pixels switchable to create an image.

### TECHNICAL FIELD OF INVENTION

The present invention relates generally to an electrowetting display which may be used, for example, in portable electronic devices and the like. More particularly, the invention relates to an electrowetting display which is switchable between transmissive and reflective modes.

### BACKGROUND OF THE INVENTION

Displays integrated into portable electronic devices often need to be readable in a wide variety of lighting conditions, from strongly directed sunshine to dark night-time conditions. The difficulty with these two extreme conditions is that they are suited to two completely different types of display. In a dark room with little or no ambient lighting, the ideal solution is an emissive display, in which the light source is integral to the display, e.g. a backlight or light-emitting pixels. In bright conditions, however, it is difficult for the light emitted from such a display to compete with the glare produced by strong sunshine on the front surface of the display. A good solution to this problem is to use a purely reflective display, in which although the glare is not necessarily omitted, at least the image observed is proportional to the glare and so the display is equally visible however strong the sun is. However, a purely reflective display cannot be viewed in dark conditions, unless it is illuminated in some way, for example by an external light source or by a front-light integrated into the display. Historically, front-light technology has not been sufficiently advanced to be used widely in reflective displays, as it usually affects the image quality observed. The alternative solution that has almost always been adopted in the case where liquid crystal displays (LCDs) are used in such applications is to divide the area of each pixel into two areas: one of which is transmissive and the other is reflective.

Although this solution is almost ubiquitous in LCDs integrated into mobile phones and other portable devices, and does allow the screens to be read in a variety of lighting conditions, it comes at quite a cost to the device performance, because of the area sharing involved. For example, for the transmissive part of the display, the aperture ratio of the LCD is smaller than it would be if the display was purely transmissive, and hence for the same brightness of backlight, the transmission of the display is dimmer. This can of course be compensated for by using a brighter backlight, but at the cost of greater power consumption. For the reflective part of the display, again the brightness is lower than would be the case for a purely reflective display due to the smaller area of reflector per pixel. In this case this is more serious as this cannot be compensated by a higher power backlight: the display simply appears dimmer in reflection. Purely reflective LCDs, especially colour ones, already have notoriously poor reflectivity (˜10-15%), even without further reductions from area sharing. In fact a typical colour transflective LCD has a reflectivity of just 3-4%, which is a very long way from the ˜70% we are used to from printed images on paper.

In view of the aforementioned shortcomings associated with conventional displays, there is a strong need for a display which includes a switchable reflector such that it is no longer necessary to share the area of the pixel between transmissive and reflective functions. If there was a switchable reflector at the back of every pixel, then it would be possible to operate the display either in transmissive or reflective mode, rather than always both at once with reduced efficiency for both modes. The choice of which mode to use at any moment in time could either be made automatically by using an ambient light sensor, or could be made manually by the user, or a combination of the two. Also, if the switchable reflector was not binary, but had some intermediate states (i.e. could act as a partial transmitter, partial reflector), then the display could also work in a mode which was quite similar to the current transflective mode, if required.

WO 03071347A1 describes a double layer electrowetting device in which each pixel includes two differently coloured droplets of oil which can be switched electrically and independently to cover either all or part of the pixel area. However, the two different coloured oils used act as subtractive colour filters (e.g. they could be any two of yellow, cyan and magenta) in order to generate colour subtractively in the display. They are not used to make a switchable reflector.

WO 2005098524A1 to Hayes et al., published Oct. 20, 2005, describes a very general electrowetting display device in which a pixel includes two immiscible fluids which can be used to electrically modulate light transmitted or reflected. However, there is no mention of using electrowetting in a double-layer configuration to make a switchable transmissive/reflective display.

WO 2007141220A1 to Feenstra Bokke, et al., published Dec. 13, 2007, describes a transflective electrowetting display in which the dual functions of transmission and reflection are achieved by dividing the area of the pixel into two, one of which is transmissive, one of which is reflective, as previously described. However, there is no mention of using electrowetting in a double-layer configuration to make a switchable transmissive/reflective display.

WO 2006017129A2 to Steckl et al., published Feb. 16, 2006, describes a transflective electrowetting display in which the dual functions of transmission and reflection are achieved either by area division, or by using a uniform partial reflector at the rear of the pixels. However, there is no mention of using electrowetting in a double-layer configuration to make a switchable transmissive/reflective display.

### SUMMARY OF THE INVENTION

The present invention relates to a display which can be switched between being transmissive or reflective via electrowetting means. This switchable reflector is in the same electrowetting cell as a second electrowetting layer which creates the image of the display, thus avoiding parallax. When incorporated into a device such as a mobile telephone, the switch between transmissive and reflective mode can be made automatically via the use of an ambient light sensor, or manually by the user (or both). The switchable reflector can also be made to switch partially across each pixel in order for the display to operate in a more traditional transflective mode. The display can also be configured so that some parts of the display work in transmission and some work in reflection. The display includes a backlight which can be switched off when the display is in reflective mode in order to save power. There can be colour filters (e.g. red, green and blue) above the pixels in order to create a coloured image.

According to an aspect of the invention, a double layer electrowetting display is provided. The electrowetting display includes a first electrowetting layer switchable between a reflective mode and a non-reflective mode; and a second electrowetting layer, adjacent the first electrowetting layer, including a plurality of pixels switchable to create an image.

According to another aspect, the first electrowetting layer is switchable between the reflective mode and a transmissive mode.

In accordance with another aspect, the first electrowetting layer includes a first electrowetting fluid, the second electrowetting layer includes a second electrowetting fluid, and the electrowetting display further includes a third electrowetting fluid interposed between the first electrowetting fluid and the second electrowetting fluid, the third electrowetting fluid being immiscible with the first electrowetting fluid and the second electrowetting fluid.

According to yet another aspect, the electrowetting display further includes a rear transparent electrode and a front transparent electrode, wherein the first electrowetting fluid is interposed between the rear transparent electrode and the third electrowetting fluid, and the second electrowetting fluid is interposed between the front transparent electrode and the third electrowetting fluid.

In accordance with still another aspect, the third electrowetting fluid is an electrically conductive fluid and serves as a common electrode between the front transparent electrode and the rear transparent electrode.

According to yet another aspect, the front transparent electrode is patterned to define the plurality of pixels within the second electrowetting layer.

According to still another aspect, the electrowetting display includes an upper substrate and a lower substrate with the first electrowetting layer and the second electrowetting layer interposed therebetween, wherein adjacent pixels are separated by pixel separator walls extending at least partially between the upper substrate and the lower substrate which prevent the first electrowetting fluid and the second electrowetting fluid within a given pixel from leaking into the adjacent pixel.

In accordance with still another aspect, at least some of the pixel separator walls extend completely between the upper and lower substrate to also serve as cell spacers.

According to another aspect, the electrowetting display includes an upper substrate upon which the front transparent electrode is formed and a lower substrate upon which the rear transparent electrode is formed, and hydrophobic layers respectively formed on the front transparent electrode and the rear transparent electrode, wherein the hydrophobic layer formed on the front transparent electrode is in surface contact with the second electrowetting fluid and the hydrophobic layer formed on the rear transparent electrode is in surface contact with the first electrowetting fluid.

In yet another aspect, the first electrowetting fluid is a reflective fluid.

According to another aspect, the second electrowetting fluid is a black fluid.

In accordance with another aspect, the third electrowetting fluid is transmissive.

In still another aspect, the first electrowetting fluid and the second electrowetting fluid are oil-based, and the third electrowetting fluid is water based.

In accordance with yet another aspect, a display system is provided including a dual layer electrowetting display as described herein, and further including a backlight adjacent the first electrowetting layer on a side opposite that of the second electrowetting layer; and a controller for selectively switching the first electrowetting layer between the reflective mode and non-reflective mode in conjunction with controlling the output of the backlight.

According to still another aspect, a method for operating a dual layer electrowetting display as described herein is provided. The method includes switching pixels in the second electrowetting layer to create the image; and selectively switching the first electrowetting layer between the reflective mode and the non-reflective mode to controllably present the image in at least two display modes included among a reflective mode, transmissive mode and transflective mode.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

FIG. 1: illustrates the concept of parallax in the context of a reflective display.

FIG. 2: illustrates three pixels in a double layer electrowetting display with no voltage applied, in the case where the water-based electrowetting fluid layer acts as a common electrode for the whole display, in accordance with an exemplary embodiment of the present invention.

FIG. 3: illustrates an exemplary pixel in a double layer electrowetting display of the type shown in FIG. 2 with no voltage applied, in the case where the electrowetting fluid layer in each pixel is electrically isolated from that in adjacent pixels, and therefore it is desirable to electrically connect to each pixel individually via conducting pillars, in accordance with another embodiment of the present invention.

FIG. 4: illustrates three pixels in a double layer electrowetting display in accordance with the embodiment of FIG. 2, with a voltage applied between the electrowetting fluid layer and a rear electrode, so that the lower electrowetting fluid layer is pushed to one side in the respective pixels, switching the device into transmissive mode. Voltage has also been applied between electrowetting fluid layer and some of the patterned front electrodes, so that the upper electrowetting fluid layer 12 in respective pixels is selectively pushed to one side in order to create some white pixels in the image.

FIG. 5: illustrates an exemplary position for the colour filters in a colour version of the invention: only the upper substrate is shown for clarity.

FIG. 6: An illustration of a display system incorporating a display in accordance with the present invention.

### KEY FOR FIGURES

1a a lower transparent substrate
1b an upper transparent substrate
2 a rear transparent electrode
3 a front transparent electrode
3a a front pixel electrode
3b a further front pixel electrode
3c a still further front pixel electrode
4 a thin-film transistor
5 black mask material
6a a lower dielectric layer
6b an upper dielectric layer
7a a lower hydrophobic layer
7b an upper hydrophobic layer
8 a lower pixel separator wall
9 an upper separator wall
10 a pixel separator that also acts as a cell spacer
11 a first oil-based electrowetting fluid
12 a second oil-based electrowetting fluid
13 a water-based electrowetting fluid
14 incident light
15 a further lower dielectric layer
16 a transparent ground electrode
16a a connector between the ground electrode and the electrowetting fluid
17r red colour filter
17g green colour filter
17b blue colour filter
18 a reflector
19a a first pixel
19b a second pixel
20a incident light
50 display system
53 display
55 backlight

### DETAILED DESCRIPTION OF THE INVENTION

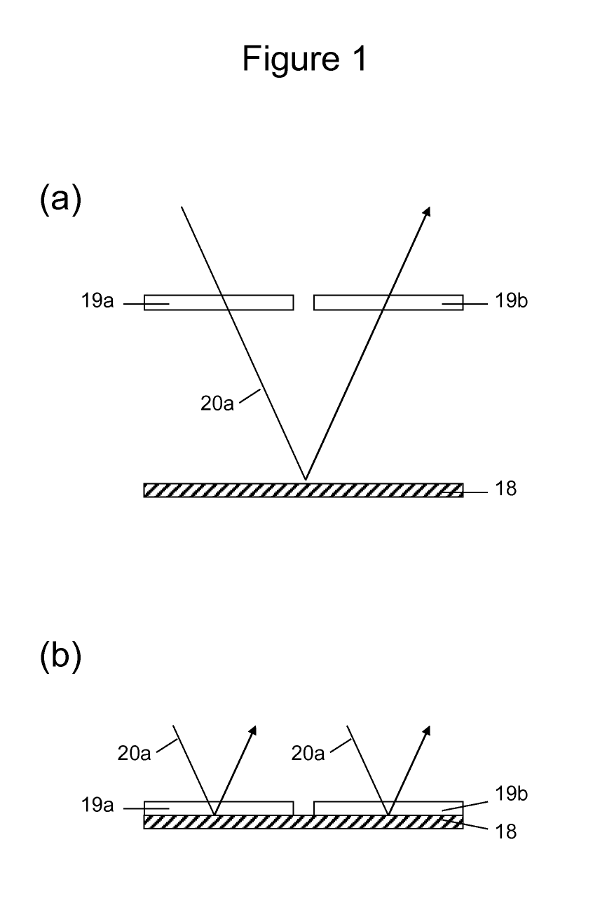

An important aspect of a switchable reflector is that it is able to be incorporated into a display such that it is directly behind, or very close to the image forming part of the display (i.e. the pixels). This is to avoid parallax effects in the display. As illustrated by FIG. 1(a), if the reflector 18 is far from the pixels 19, light 20a that enters the display beyond a certain angle to the normal to the display through a first pixel 19a will be reflected back through the adjacent pixel 19b. The light emerging from the display at a particular point can therefore contain information from both pixels 19a and 19b, leading to crosstalk between pixels. This is of course assuming that the pixels themselves are transmissive, and it is simply the reflector which makes the display reflective. However, this is very likely to be a necessary requirement for a switchable transmissive/reflective display. If the reflector 18 is close to the pixels (FIG. 1(b)), however, parallax effects are avoided.

The ideal situation is in fact if the switchable reflector is actually inside the pixel itself, a situation which is often referred to as “in-cell”. A display technology which lends itself very well to this concept is that of electrowetting. Electrowetting displays are a very promising emerging technology with the potential to out-perform LCDs even without the prospect of extra brightness by having a switchable transmissive/reflective function. According to the present invention, it is possible to create two optical switches within a single cell. The upper one can be used to generate the image and the lower one can be used to make a switchable reflector.

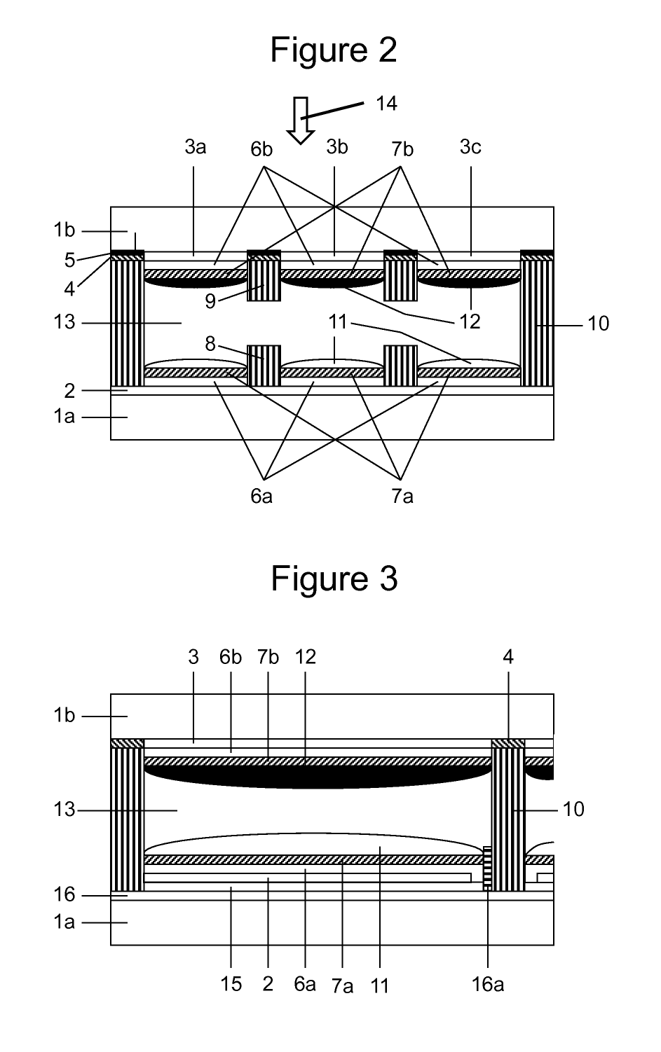

A preferred embodiment of a display in accordance with the present invention is illustrated in FIG. 2. The display is contained between two transparent substrates 1a and 1b, made for example from glass or plastic. On both of these two substrates are disposed conductive rear and front transparent electrode layers 2 and 3, respectively, which will be used to control the rear and front electrowetting switchable elements respectively. Since the front electrowetting layer will be used to generate the image of the display, the front transparent electrode layer 3, or first electrode, is necessarily patterned so that different voltages can be applied to different pixels, in order to generate an image. The individual pixel electrodes (3a, 3b, 3c, etc) may therefore be connected to thin film transistors 4. The thin-film transistors may be masked by a black material 5, otherwise ambient light reflected from them could degrade the contrast of the display. The positioning of the thin-film transistors 4 relative to the other parts of the display will usually be done in such a way as to optimise the optical performance of the display. For example, the transistors 4 will often be located vertically above the walls between adjacent pixels (e.g., separator walls 8, 9 and 10) in order to decrease as little as possible the aperture ratio of the display.

The rear transparent electrode layer 2, or second electrode, need not be patterned as it will be used to control the switchable reflector in the display, and it will generally be the case that the display should either be completely in transmissive mode or completely in reflective mode. However, if it is required that the switching of the rear reflector should be pixelated, then it will be necessary also to pattern the rear transparent electrode layer 2, and to provide some means of driving each area of that layer independently. If the independent areas are relatively few across the display this will not necessarily require active-matrix control, but if the number of areas are numerous or even one per pixel, then thin-film transistors (not illustrated in FIG. 2) will be required just as for the front individual pixel electrodes 3a, 3b, 3c, etc.

Upon both transparent electrode layers 2 and 3 are deposited an optional dielectric layer 6, and a hydrophobic layer 7. The optional dielectric layer 6 acts as an insulator between the outer electrodes of the display (i.e., rear and front transparent electrode layers 2 and 3, respectively), and an inner or third electrode 13 (which will be described below). For example, the dielectric layer 6 is made from a highly insulating and non-porous material such as silicon oxide, silicon nitride or Parylene. A high dielectric permittivity is advantageous in lowering the drive voltage required, so materials such as aluminium oxide, hafnium oxide or barium titanate are also suitable. The thickness of the dielectric layer 6 also affects the required drive voltage and is therefore kept as low as possible: in many cases the thickness of the dielectric layer 6 will be less than 1 μm, although not for all the dielectric materials mentioned here.

The hydrophobic layer 7 is also a thin insulating layer and will generally be a commercially available material of Teflon, Cytop or Parylene. Separating the pixels of the display are pixel separator walls 8 and 9. The purpose of the pixel separator walls is to prevent the electrowetting fluids belonging to a particular pixel from leaking into adjacent pixels. The surface of the pixel separator walls can also be coated with surface layers (not shown) in order to influence the arrangement of the electrowetting fluids both in the driven and undriven states. For example, by using a patterned hydrophilic layer on the pixel separator walls, it is possible to influence the direction of the electrowetting fluid motion when a drive voltage is applied. The pixel separator walls 8 and 9 can be isolated elements situated on opposite substrates 1a, 1b, and not in physical contact. Alternatively, there can in fact be a single pixel separator wall 10 between pixels which extends from one substrate 1a to the other 1b and therefore also acts as a cell spacer.

In between the substrates 1a, 1b within the respective pixels are positioned electrowetting fluids 11, 12, 13. Fluids 11 and 12 are oil-based fluids, and are immiscible with fluid 13 which is a water-based fluid. However, the respective fluids 11 and 12 may be miscible with each other. As described in more detail below, the fluids 11 and 12 form first and second switchable electrowetting layers, respectively.

More specifically, fluid 11 forms part of a switchable electrowetting layer representing the switchable reflector part of the display. The electrowetting layer is switchable between a reflective mode and a non-reflective mode. In the non-reflective mode, the fluid 11 is distributed within the pixels so as to be less reflective than the fluid 11 as distributed in the reflective mode. A reflective oil suitable for use as the fluid 11 may be made by dissolving scattering or reflective particles such as metal particles or nanoparticles, or scattering dielectric particles such as titanium dioxide into a transparent oil such as dodecane. Titanium dioxide particles, when smaller than the wavelength of visible light (e.g. ˜200 nm) are very efficient scatterers of visible light, due to their high refractive index (2.5-3), and are commonly used as a pigment for white paints and plastics. It is possible to disperse titanium dioxide particles in an oil such as dodecane by using a dispersing agent such as Borchi Gen 911 from Borchers. The titanium dioxide particles remain dispersed in the dodecane for long periods of time, and do not disperse in the adjacent water-based electrowetting fluid 13. The thickness of fluid 11 in a given pixel in the undriven state (with no voltage applied thereto) should ideally be sufficient to make it opaque to light 14 incident from the top of the display, and therefore an efficient reflector.

The reflectivity achievable from thick dodecane layers with titanium dioxide particles in suspension can easily exceed that of standard white paper. However, if it is necessary to make the layer of fluid 11 thinner for other reasons (e.g. overall device thickness or speed) then all that will happen is that the reflectivity will be slightly lower when the display is reflective mode: the transmissive mode will not be affected.

Fluid 12 forms part of a switchable electrowetting layer in optical alignment with the switchable reflector, and represents the image forming part of the display. In most cases the fluid 12 will be black so as to provide maximum absorption. A suitable fluid 12 would be again an oil such as dodecane, with a non-polar black dye dissolved within it. In order to provide a good quality image with good contrast ratio, the thickness of the layer of fluid 12 in the undriven state should ideally be sufficient to absorb all of the incident visible light 14. However, if it is necessary to make the fluid layer 12 thinner for other reasons (e.g. overall device thickness or speed) then this will simply increase the amount of light either transmitted or reflected (depending in which mode the display is in) in the dark parts of the image, therefore lowering the contrast ratio of the display. This is more serious in transmissive mode, as the light will pass through the fluid 12 only once, compared with twice for the reflective mode.

The fluid 13 is a conductive water-based fluid for example, water, or a mixture of water and ethyl-alcohol. In the exemplary embodiment, the fluid 13 is optically transmissive, and preferably transparent. As mentioned previously, fluid 13 also acts as a third electrode for the device, and must therefore be connected to the control circuitry. This is because it is the voltage difference between fluid 13 and either rear or front transparent electrode layers 2 or 3 that drives a change in the shape and position of the fluids 11 and 12, respectively, relative the hydrophobic layers 7, i.e. the electrowetting effect. A simple way to do this is to connect fluid 13 to electrical ground, and selectively apply signal voltages to transparent electrode layers 2 and 3, although this is not the only method of driving the display in accordance with the present invention. Whatever the method of driving, it is necessary to make an electrical connection to the fluid 13 from the external circuitry of the display. A method of doing this is depicted in FIG. 3, for the case where the grounding is made via the lower substrate 1a (it could equally well be done via the upper substrate 1b). Beneath the transparent electrode layer 2 within a given pixel there is provided an insulating dielectric layer 15, and a transparent ground electrode 16. The transparent electrode 16 is planar apart from a small pillar 16a which connects the fluid 13 with the planar part of the ground electrode 16, which is common to the entire display. The dielectric layers 15 and 6, transparent electrode layer 2, and hydrophobic layer 7 are necessarily patterned to accommodate the conducting pillar 16a, but electrode layer 2 can nonetheless be common to every pixel of the display. If the fluid 13 forms a single, connected reservoir throughout the display device (which would be the case if pixel separator walls 8, 9 are used rather than pixel separator walls 10, or if the pixel separator walls 10 have holes at certain positions of the pixel in order to allow fluid 13 to be one continuous reservoir), then it is sufficient to make a single ground connection to fluid 13, i.e. there needs to be only one pillar 16a for the entire display, although certainly more than one ground connection may be formed in similar manner. If, however, all of the fluids in each pixel (including fluid 13) are completely separated from each other by pixel separator walls 10, then it will be necessary to ground the fluid 13 in each pixel, i.e. there will be one pillar 16a per pixel.

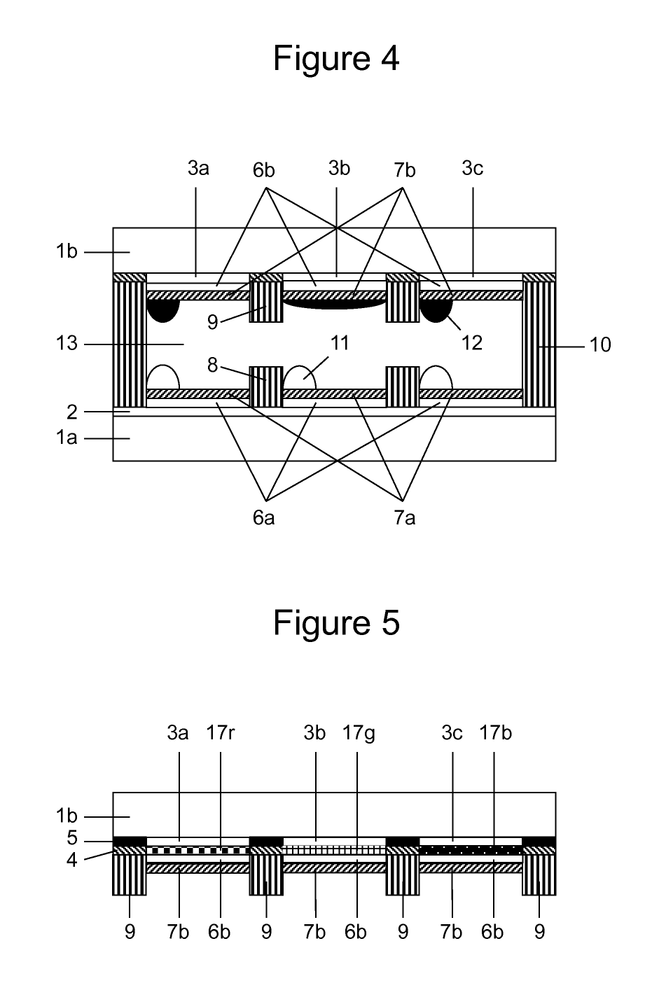

FIG. 2 shows the device when no drive voltage is applied to move the electrowetting fluids 11, 12 and 13 from their equilibrium positions. FIG. 4 shows an example of a driven device. For instance, when a voltage is applied between fluid 13 and rear transparent electrode layer 2, fluid 13 will move in such a way as to wet the lower hydrophobic layer 7a, pushing fluid 11 to the side, up against the pixel separator wall(s) 8 and/or 10. A similar effect on fluid 12 is achieved by applying a voltage between fluid 13 and the front electrode layer 3, except that the movement is used for different purposes.

Namely, fluid 11 will be moved (in most applications identically in each pixel of the display) in order to switch from reflective mode (0V) to transmissive mode (voltage on). Fluid 12, however, will be moved (in general) by different amounts in different pixels in order to create an image on the display, as illustrated in FIG. 4. For example, FIG. 4 shows two white pixels on either end and one black pixel in the middle. As described so far, the display is monochrome, i.e. it can display black or white pixels. One way to generate greyscale is to control the voltage applied to the pixel electrodes 3a, 3b, 3c, etc. to be intermediate between those required for complete black (0V) and complete white. An alternative is to use temporal dither to switch the fluid 12 quickly between the black (0V) and white (voltage on) positions, and rely on the finite response speed of the human eye to perceive an average brightness which is intermediate between the two extremes of black and white. A coloured image can be created by adding colour filters 17r, 17g and 17b above the electrowetting element. In principle these could be located anywhere above the fluids. As illustrated in FIG. 5, in practice the most sensible place to place them is likely to be beneath the pixel electrodes 3a, 3b, 3c, etc., and above the hydrophobic layer 7b: they could go either side of the dielectric layer 6b or even form part of it.

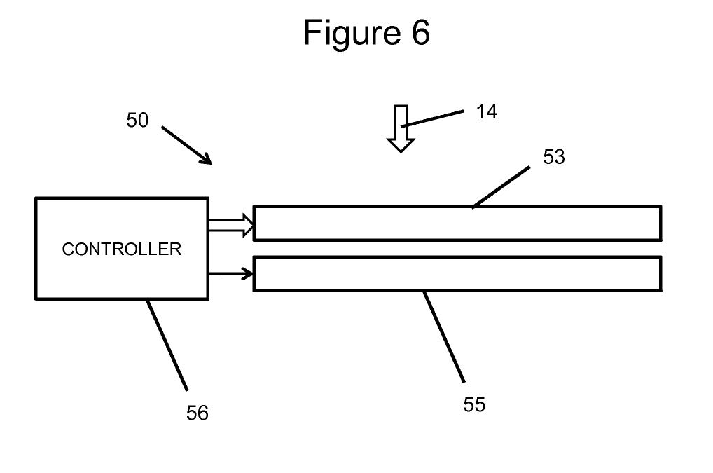

FIG. 6 illustrates a display system 50 incorporating a display 53 in accordance with the present invention. The display 53 may be a display in accordance with any of the embodiments of the invention as described above with respect to FIGS. 2 through 5. The display system 50 may be included in various portable devices such as mobile phones, media players, portable computers, personal organizers, etc. Moreover, the display system 50 may be utilized in various other types of devices incorporating a display, such a flat panel televisions, monitors, etc.

The display system 50 includes a backlight 55 incorporating a light source such as a fluorescent bulb, light emitting diode (LED) array, etc. Light from the backlight 55 is incident on the lower transparent substrate 1a of the display 53 (see, e.g., FIG. 2). Front light 14 (e.g., ambient light) is incident upon the upper transparent substrate 1b of the display 53 as exemplified in FIG. 2.

Included also within the display system 50 is a controller 56 for providing the appropriate control and image data to the display 53. For example, the controller 56 causes the display 53 to operate in the reflective mode by applying zero voltage across the fluid 11 via the rear transparent electrode layer 2 and the electrically conductive fluid 13 (see FIG. 2). At such time, the controller 56 turns off the backlight 55 to reduce power consumption. Alternatively, the controller 56 causes the display 53 to operate in the transmissive mode by applying a non-zero voltage across the fluid 11 via the rear transparent electrode layer 2 and the electrically conductive fluid 13 (see FIG. 3). In the transmissive mode, the controller 56 turns on the backlight 55 to provide backlighting to the display 53. As previously noted, the controller 56 may be configured to switch between the reflective mode and the transmissive mode based on a user input, an ambient light sensor, a combination thereof, etc.

In a combined transmissive/reflective mode, the controller 56 is configured to provide selected portions of the rear transparent electrode layer 2 (appropriately patterned) with a drive voltage so as to be in a transmissive mode, and other portion with no drive voltage so as to be in a reflective mode. In such case, the controller 56 causes the backlight 55 to be on for purposes of the transmissive mode. In another embodiment, the controller 56 may control the reflectivity of the fluid 11 so as to include intermediate states between fully transmissive and fully reflective by applying intermediate voltages thereacross.

In both the transmissive mode and reflective mode, the controller 56 is configured to provide a drive voltage selectively, with respect to each pixel, across the fluid 12 via the front transparent electrode layer 3 (e.g., 3a, 3b, 3c, etc.) and the electrically conductive fluid 13. As described above, the particular voltages provided to the particular pixels is based on the image data to be displayed via the display 53. Appropriate circuitry for providing image data voltages to respective pixels in an active matrix display is well known, and therefore further detail is omitted herein for sake of brevity.

Although the invention has been shown and described with respect to certain preferred embodiments, it is obvious that equivalents and modifications will occur to others skilled in the art upon the reading and understanding of the specification. The present invention includes all such equivalents and modifications, and is limited only by the scope of the following claims.

### INDUSTRIAL APPLICABILITY

An electrowetting display device is provided which is switchable between a transmissive mode and a reflective mode. The display may be used in portable devices such as mobile phones, media players, portable computers, personal organizers, etc. Moreover, the display device may be utilized in various other types of devices incorporating a display, such a flat panel televisions, monitors, etc.

1. A double layer electrowetting display, comprising:
a first electrowetting layer switchable between a reflective mode and a non-reflective mode; and
a second electrowetting layer, adjacent the first electrowetting layer, including a plurality of pixels switchable to create an image.

2. The electrowetting display according to claim 1, wherein the first electrowetting layer is switchable between the reflective mode and a transmissive mode.

3. The electrowetting display according to claim 1, wherein the first electrowetting layer comprises a first electrowetting fluid, the second electrowetting layer comprises a second electrowetting fluid, and the electrowetting display further comprises a third electrowetting fluid interposed between the first electrowetting fluid and the second electrowetting fluid, the third electrowetting fluid being immiscible with the first electrowetting fluid and the second electrowetting fluid.

4. The electrowetting display according to claim 3, further comprising a rear transparent electrode and a front transparent electrode, wherein the first electrowetting fluid is interposed between the rear transparent electrode and the third electrowetting fluid, and the second electrowetting fluid is interposed between the front transparent electrode and the third electrowetting fluid.

5. The electrowetting display according to claim 4, wherein the third electrowetting fluid is an electrically conductive fluid and serves as a common electrode between the front transparent electrode and the rear transparent electrode.

6. The electrowetting display according to claim 4, wherein the front transparent electrode is patterned to define the plurality of pixels within the second electrowetting layer.

7. The electrowetting display according to claim 3, comprising an upper substrate and a lower substrate with the first electrowetting layer and the second electrowetting layer interposed therebetween, wherein adjacent pixels are separated by pixel separator walls extending at least partially between the upper substrate and the lower substrate which prevent the first electrowetting fluid and the second electrowetting fluid within a given pixel from leaking into the adjacent pixel.

8. The electrowetting display according to claim 7, wherein at least some of the pixel separator walls extend completely between the upper and lower substrate to also serve as cell spacers.

9. The electrowetting display according to claim 4, comprising an upper substrate upon which the front transparent electrode is formed and a lower substrate upon which the rear transparent electrode is formed, and hydrophobic layers respectively formed on the front transparent electrode and the rear transparent electrode, wherein the hydrophobic layer formed on the front transparent electrode is in surface contact with the second electrowetting fluid and the hydrophobic layer formed on the rear transparent electrode is in surface contact with the first electrowetting fluid.

10. The electrowetting display according to claim 3, wherein the first electrowetting fluid is a reflective fluid.

11. The electrowetting display according to claim 3, wherein the second electrowetting fluid is a black fluid.

12. The electrowetting display according to claim 3, wherein the third electrowetting fluid is transmissive.

13. The electrowetting display according to claim 3, wherein the first electrowetting fluid and the second electrowetting fluid are oil-based, and the third electrowetting fluid is water based.

14. A display system, comprising:
a dual layer electrowetting display according to claim 1;
a backlight adjacent the first electrowetting layer on a side opposite that of the second electrowetting layer; and
a controller for selectively switching the first electrowetting layer between the reflective mode and non-reflective mode in conjunction with controlling the output of the backlight.

15. A method for operating a dual layer electrowetting display according to claim 1, comprising:
switching pixels in the second electrowetting layer to create the image; and
selectively switching the first electrowetting layer between the reflective mode and the non-reflective mode to controllably present the image in at least two display modes included among a reflective mode, transmissive mode and transflective mode.
